(19) United States
(12) Patent Application Publication
(10) Pub. No.: US 2013/0085730 A1
(43) Pub. Date: Apr. 4, 2013

(54) PRECONDITIONER FOR RESERVOIR SIMULATION

(71) Applicants: Gareth J. Shaw, Sutton Courtenay (GB); Garfield Bowen, Brightwell-cum-Sotwell (GB); Dominic Walsh, Oxford (GB)

(72) Inventors: Gareth J. Shaw, Sutton Courtenay (GB); Garfield Bowen, Brightwell-cum-Sotwell (GB); Dominic Walsh, Oxford (GB)

(21) Appl. No.: 13/633,159

(22) Filed: Oct. 2, 2012

Related U.S. Application Data
(60) Provisional application No. 61/543,192, filed on Oct. 4, 2011.

(51) Int. Cl. G06F 17/11

(52) U.S. Cl. 703/2

(57) ABSTRACT

A method can include providing a system of equations with associated variables that describe physical phenomena associated with a geologic formation; decoupling the system of equations to provide a system of pressure equations with associated pressure variables; solving the system of pressure equations for values of the pressure variables; and, based at least in part on the values of the pressure variables, solving the system of equations for values of the associated variables where the solving the system of equations includes applying a block approximate inverse preconditioner technique to at least blocks of mass conservation terms of the system of equations. Various other apparatuses, systems, methods, etc., are also disclosed.

### RELATED APPLICATION

This application claims the benefit of the U.S. Provisional Patent Application having Ser. No. 61/543,192, filed on Oct. 4, 2011, entitled “Massively Parallel Linear solvers in Reservoir Simulation,” the disclosure of which is incorporated by reference herein in its entirety.

### BACKGROUND

Reservoir simulation involves modeling various physical phenomena over a geologic environment. A model may involve spatially gridding a geologic environment for purposes of discretizing equations that describe physical phenomena. For a particular geologic environment, such a model may include millions of equations with millions of unknowns. A solver may structure the equations and unknowns in the form of vectors, matrices, etc. Depending on relationships between variables, locations of features within a geologic environment, etc., a solver may structure a matrix that tends to be sparse and, possibly, poorly conditioned (e.g., according to a condition number). Various technologies, techniques, etc., described herein can include applying a preconditioner, for example, to a sparse matrix for purposes of solving for unknowns of equations that describe physical phenomena of a geologic environment.

### SUMMARY

A method can include providing a system of equations with associated variables that describe physical phenomena associated with a geologic formation; decoupling the system of equations to provide a system of pressure equations with associated pressure variables; solving the system of pressure equations for values of the pressure variables; and, based at least in part on the values of the pressure variables, solving the system of equations for values of the associated variables. In such a method, solving the system of equations can include applying a block approximate inverse preconditioner technique to at least blocks of mass conservation terms of the system of equations. A system can include a multi-core GPU, memory and instructions stored in the memory and executable by the multi-core GPU to, based at least in part on values of pressure variables of a system of equations with associated variables that describe physical phenomena associated with a geologic formation, apply a block approximate inverse preconditioner technique to at least blocks of mass conservation terms of the system of equations to solve the system of equations for values of the associated variables. A system can include processor cores, memory and instructions stored in the memory and executable at least in part in parallel by the processor cores to implement a constrained pressure residual method that includes an approximate inverse smoother, a block approximate inverse preconditioner, or an approximate inverse smoother and a block approximate inverse preconditioner. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geologic environment;

FIG. 2 illustrates an example of a flowchart that includes a linear solver for solving a system of equations;

FIG. 3 illustrates examples of equations associated with a two stage preconditioner method;

FIG. 4 illustrates an example of a solver and an example of a parallel computing architecture;

FIG. 5 illustrates an example of a subterranean formation with a well and a matrix;

FIG. 6 illustrates an example the subterranean formation with a reduced matrix;

FIG. 7 illustrates an example of a matrix and an example of a system;

FIG. 8 illustrates an example of equations and an example of a matrix;

FIG. 9 illustrates an example of a method;

FIG. 10 illustrates an example of a method and an example of a system; and

FIG. 11 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Subterranean formations, and related physical phenomena, may be modeled using various techniques. Such techniques can involve gridding, or other discretization, of one or more subterranean volumes that make up a formation. Where a formation includes one or more fluids (e.g., gas, liquid, or both), a modeling technique may also include formulating equations that account for physical phenomena such as pressure, saturation and composition. As an example, consider an oil and gas field that spans a volume measured in kilometers. A model of such a field may include many thousands of grid cells or grid points where each cell or point has associated pressure, saturation and composition values, which may be equation unknowns, for example, optionally with respect to time. Given initial values (e.g., initial conditions) and boundary values (e.g., boundary conditions), an iterative solution technique may be applied to the model equations to determine the equation unknowns at one or more points in time (e.g., steady-state or transient).

As physical phenomena related to a subterranean formation may be interrelated, model equations may be coupled to varying degrees. Resulting mathematical matrices that represent coupled systems of equations may be “sparse” with many zero entries and many off-diagonal terms. For large matrices, an algorithm can account for “sparsity”; noting that failure to account for sparsity can result in increased storage and computational demands. Transformation techniques such as preconditioning can help improve the “condition” of a matrix (e.g., to avoid an ill-conditioned system of equations). Preconditioning can reduce the condition number of a system and thereby improve convergence of an iterative solution technique, improve computational stability and improve trust in the solution values for unknowns.

In mathematics, the generalized minimal residual method (usually abbreviated GMRES) is an iterative method for the numerical solution of a system of linear equations. The method approximates the solution by a vector in a Krylov subspace K with minimal residual where the Arnoldi iteration may be used to find the vector. GMRES approximates the exact solution of Ax=b by the vector xₙεKₙ that minimizes the Euclidean norm of the residual Axₙ−b.

Krylov subspace methods such as GMRES or Orthomin find use as basic solvers, which may be implemented in parallel. However, efficiency of these solvers relies on defining a suitable preconditioner to improve the condition number of a linear system.

Preconditioners (e.g., preconditioning techniques) are useful in iterative methods that can solve a linear system of equations such as Ax=b for unknowns of vector x. This is because the rate of convergence of these iterative methods tends to improve as the condition number of the matrix A decreases. Thus, for such scenarios, preconditioning the system improves the convergence. Preconditioning involves selection of a matrix P, such that the preconditioned system may be represented as, for example: P⁻¹Ax=P⁻¹b.

One criterion for preconditioning is that the preconditioning matrix may be readily inverted. Further, to reduce the number of iterations, it may also be desirable that P be “close” to A in the sense that the spectral radius of I−P⁻¹A be small, where I is the identity matrix (i.e., entries of unity along a main diagonal and zeros elsewhere). Preconditioning can present trade-offs between performing a small number of intensive iterations and a large number of less intensive iterations. Preconditioning may be “left-sided”, “right-sided” or both left- and right-sided (e.g., two-sided).

As an example, an approach to preconditioning a system of reservoir equations can be achieved via implementation of a constrained pressure residual (CPR) method. In part, a CPR method acts to reduce or decouple a full system of equations for pressure variables and other variables to a set of equations for pressure variables. As an example, reduction or decoupling may occur using an implicit pressure and explicit saturations (IMPES) reduction, for example, a true-IMPES or a quasi-IMPES reduction may be implemented. As an example, after extracting and solving a pressure subsystem, a first stage of a CPR method provides a pressure solution along with residuals, which are corrected in a second stage of the CPR method with an additional preconditioning step (to recover global information of the system).

In the aforementioned approach, the resulting pressure equation tends to be parabolic, for example, with coefficients resembling a Poisson equation (e.g., Δφ=f, where Δ is the Laplace operator, and f and φ are real or complex-valued functions on a manifold). Such an equation can be well-suited to a solution using multigrid methods (consider algebraic multigrid “AMG” methods). As an example, casting the pressure equation in such a form, solving for and updating pressure variables may be followed by updating a full set of variables by applying a second stage preconditioner to a full system of equations (e.g., for a solution to the full set of variables). In a CPR method, the second stage preconditioning tends to be a stationary iterative method such as block Gauss-Seidel or block incomplete LU factorization (abbreviated “ILU”); noting that a CPR method may include smoothing in a first stage, for example, using a Gauss-Seidel approach that acts to reduce high frequency errors in a pressure solution.

AMG methods find use in solving sparse linear systems where construction of a coarse grid may be problematic (e.g., consider a coarse grid matrix Q, as in a multigrid Galerkin approach). Various AMG methods construct a coarse grid using elements in a coefficient matrix A where the convergence factor can depend polynomially on the number of hierarchical levels implemented. AMG methods may be characterized by subsets of unknowns, for example, without geometric interpretation. As such, AMG methods may also be referred to as “algebraic multilevel methods” (e.g., without reference to a grid). An AMG method can include a recursive setup phase (e.g., with interpolations and restrictions) for a number of levels to provide a coarse matrix for a linear system followed by a solution phase that implements smoothing, coarse grid correction, etc.

Various AMG methods may be implemented, at least in part, in parallel, for example, by partitioning, which can be applied to matrices at each level. For example, interpolations, restrictions and computation of a coarse matrix may be achieved in parallel with appropriate attention to communication (e.g., appropriate interrelationships across parallel computing threads). As to a solution phase, restrictions and interpolations may be subject to parallelization, however, smoothers such as Gauss-Seidel or ILU are serial (e.g., not readily subject to parallelization).

In various AMG methods discussed, decoupling is not inherent. In contrast, decoupling is part of a CPR method (i.e., CPR is the abbreviation of “constrained pressure residual”). Thus a CPR method may be viewed as including a decoupler that produces a first stage pressure system which may be solved using an AMG method (including a smoother), and a second stage preconditioner that acts to “recouple” the full system of equations.

As an example, for a CPR preconditioner, a pressure equation may be solved using an AMG method and an approximate inverse smoother (AI smoother) may be applied as part of the first stage preconditioning process. In such an example, the AI smoother may provide for parallel processing (e.g., in contrast to Gauss-Seidel or ILU serial smoothing). As to the second stage, a preconditioner may be implemented that can optionally provide for parallel processing. For example, a two stage preconditioner solver may implement a block approximate inverse preconditioner (block AI preconditioner) as a second stage preconditioner.

As to approximate inverse techniques (e.g., AI techniques), the following documents describe some examples: Frederickson, P.O., 1974, “Fast approximate inversion of large elliptic systems”, Report 7-74: Lakehead University; Benzi, M., et al., 1999, “A comparative study of sparse approximate inverse preconditioners”, Appl. Numer. Math., 30(2-3), 305-340; and Benzi, M., et al., 1996, “A sparse approximate inverse preconditioner for the conjugate gradient method. SIAM J. Sci. Comput., 17(5), 1135-1149”, which are incorporated by reference herein. As an example, a block AI preconditioner may be a block variant of one or more of the AI techniques described in the foregoing documents.

As an example of the AI technique of Frederickson (1974), consider a sparse linear system of n equations

Ax=b (1)

where A is an n×n matrix with entries denoted

An AI preconditioner can define a sparsity structure for a matrix P, which can be used as a preconditioner (or a smoother), and can attempt to make P close to the inverse of A, as appropriate. In such an example, the sparsity structure S may be defined to be the same as that for A:

S={(i,j):aᵢⱼ≠0} (2)

or, for example, it may be that of A^{T}, or indeed other matrices, such as powers of A, A^{T}, or A^{T}A. Other approaches may allow the sparsity structure to evolve as a preconditioner is constructed.

Given a sparsity structure for P, an approach may act to choose its elements such that P approximates the inverse of A. This can be accomplished, for example, by minimizing the matrix Frobenius norm:

μI−PA∥_{F} (3)

where

μA∥_{F}=\sqrt{Σᵢ₌₁ⁿΣⱼ₌₁ⁿ|aᵢⱼ|²}=\sqrt{trace(A*A)} (4)

which may be viewed, for example, as being equivalent to minimizing the difference between the elements of I and PA in the I₂ norm.

As an example, another approach can act to ensure that elements of the product matrix PA match those of the identity matrix I within a sparsity pattern (e.g., within a sparsity structure S):

(I−PA)ᵢⱼ=0, for all (i,j)εS (5)

In the foregoing example, a left preconditioner is described. A right preconditioner may be defined without loss of generality, by replacing PA by AP in the foregoing equations (3) and (5).

As an example, an approach described below pertains to a left preconditioner; noting that it may be applicable to a right preconditioner. Assuming that a sparsity pattern is chosen a priori (e.g., rather than using a dynamic approach), consider a sparsity pattern of P that is the same as that of A^{T}. Given the foregoing assumptions, a Frobenius approach and a Frederickson approach may be considered for choosing entries of P.

Let row i of A be denoted aᵢ^{T}, for i=1, 2, . . . , n, so that

$$A = ( \begin{matrix}{\underline{a}}_{1}^{T} \\ ⋮ \\ {\underline{a}}_{n}^{T}\end{matrix} ) \qquad ( 6 )$$

Equation (6) shows the transpose of row i of A as being a vector. Equivalent notation can be assumed for other matrices, such as P. As an example, each row of P may be constructed independently of other rows of P. Now consider row i and let sparsity structure Sᵢ denote a set of non-zero locations in row i of P:

Sᵢ={j:p_{i,j}≠0}. (7)

For a Frobenius norm, a method includes minimizing the error in a solution of a system as follows:

Σ_{jεS}_{ᵢ}p_{i,j}aⱼ^{T}=eᵢ^{T} (8)

where eᵢ^{T} is the ith unit vector, which is zero except for entry i, which is one. Letting indices including the set Sᵢ be denoted {j₁, j₂, . . . , jₘ}, a method can include assembling a n×m matrix:

Mᵢ=(aⱼ_{₁} . . . aⱼ_{ₘ}) (9)

and a m-vector:

$${\underline{p}}_{i} = ( \begin{matrix}{p}_{i , {j}_{1}} \\ ⋮ \\ {p}_{i , {j}_{m}}\end{matrix} ) \qquad ( 10 )$$

Given the foregoing, equation (8) can be rewritten as:

Mᵢpᵢ=eᵢ (11)

Equation (11) represents a system of n equations in m (<n) unknowns. To obtain a least-squares solution, which minimizes the Frobenius norm of μI−PA∥_{F}, one approach is to solve the normalized system:

Mᵢ^{T}Mᵢpᵢ==Mᵢ^{T}eᵢ (12)

or more concisely:

Vᵢpᵢ=wᵢ (13)

As an example, construction of a Frobenius AI preconditioner for row-wise application, can include for row i: (i) taking scalar products of each sparse row in the set Sᵢ with every other row to populate the m×m matrix Vᵢ; (ii) selecting the ith row of Mᵢ to define wᵢ; and (iii) solving a “small” linear system (13) for pᵢ and setting non-zero entries in P accordingly.

As an example, for a Frederickson AI preconditioner method, consider equation (11). In such an example, rather than converting to a least squares system as in equation (12) of a Frobenius approach, such a method can include selecting those rows of equation (11) which correspond to the indices in Sᵢ. Such an approach yields a m×m system to solve.

As an example, application of a sparse block AI preconditioner can be via a sparse matrix-vector product in a second stage of a CPR method. As an example, an AI smoother can be applied to a partitioned matrix, for example, for a first stage of a CPR method. As an example, a CPR method can include parallel processing where such parallel processing applies one or more AI techniques (e.g., AI smoothing, block AI preconditioning, etc.).

Linear systems arising in reservoir simulation and other application areas may exhibit a block structure. As an example, a system may be viewed as a sparse matrix where each entry is itself a small dense block. As an example, an efficient preconditioner for such a system can facilitate high performance simulation (e.g., high performance reservoir simulators).

AI preconditioners have some advantages for block systems. For example, if several rows of P have the same sparsity pattern they have the same matrix Mᵢ and therefore the same Vᵢ. In such a scenario, it is not necessary to recalculate various required scalar products; a method can proceed by calculating the right-hand side vector wᵢ for each different row.

A block sparse matrix may be viewed as a particular case of the foregoing scenario where each row of an approximate inverse can be computed independently. Given that rows within a particular block have the same sparsity pattern, the Vᵢ matrix may be calculated once for each block. As an example, it can also be factorized and, for LU factorization, the L and U factors can be stored for more efficient repeated solution of linear systems involving Vᵢ. Coefficients for each row of P within the block can be found by forming the right-hand side wᵢ and then solving equation (13) (e.g., Vᵢpᵢ=wᵢ).

As to the aforementioned, Fredrickson method, efficiencies may exist; noting that while scalar products calculations may be unnecessary, a method may save the factorization of a m×m system and share it across rows in a block.

Since each row of an AI preconditioner can be calculated independently (e.g., application as a matrix-vector product), parallel processing may be implemented. As an example, efficient implementation may occur in parallel within a domain decomposition paradigm without algorithmic approximation. In other words a parallel processing implementation may be algorithmically identical to a serial processing implementation. Such characteristics facilitate checking correctness of a parallel processing implementation and achieving parallel scalability on massively parallel machines. Preconditioners such as ILU preconditioners do not exhibit such characteristics and, as number of parallel sub-domains is increased, algorithmic performance of the ILU preconditioner degrades, and some parallel scalability is lost.

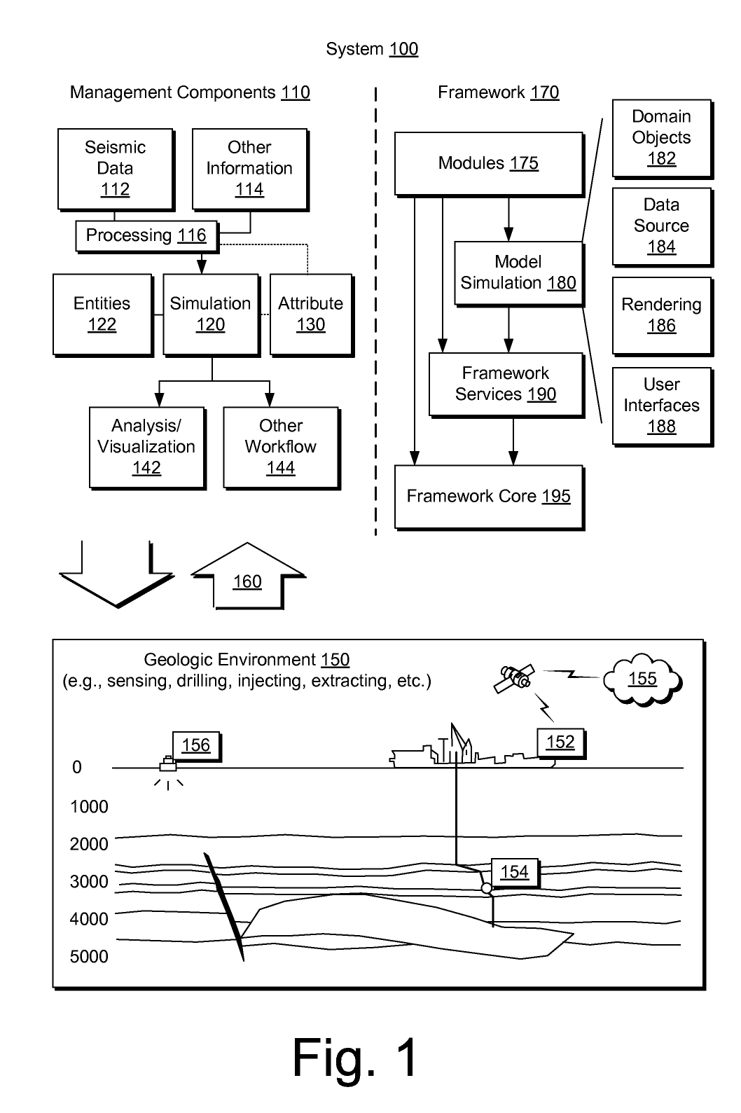

FIG. 1 shows an example of a system 100 that includes various management components 110 to manage various aspects of a geologic environment 150 (e.g., an environment that includes a sedimentary basin). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT®.NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. As an example, output from the simulation component 120 may be input to one or more other workflows, as indicated by a workflow component 144.

In an example embodiment, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc.

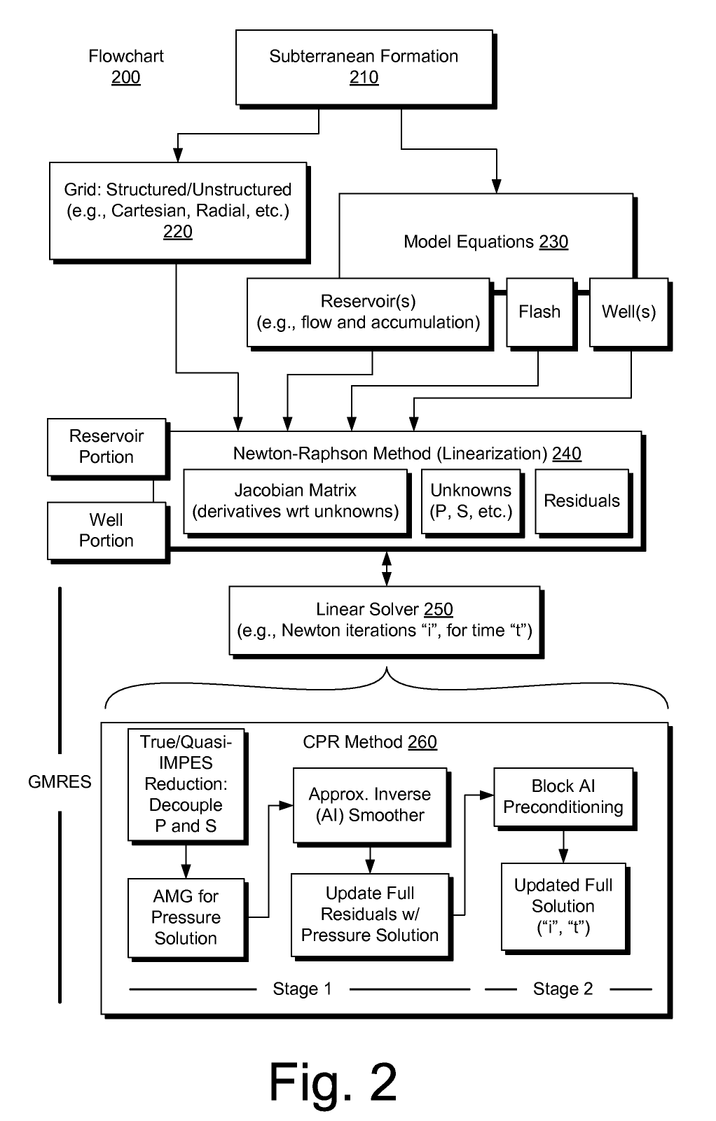

FIG. 2 shows a flowchart 200 of an example of a process for simulating physical phenomena associated with a subterranean formation 210. In the example of FIG. 2, grid block 220 provides for gridding a surface, a volume, etc., to represent the subterranean formation 210 while a model block 230 provides equations for modeling physical phenomena associated with the subterranean formation 210. The equations of the model block 230 may be discretized or otherwise described with respect to one or more grids as provided by the grid block 220 (e.g., structured, unstructured, structured and unstructured).

As an example, reservoir simulation can involve numerical solution of a system of equations that describes the physics governing complex behaviors of multi-component, multiphase fluid flow in porous media of a subterranean reservoir. A system of equations may be formulated as coupled nonlinear partial differential equations (PDEs). Such PDEs may be discretized spatially and optionally temporally with respect to one or more grids. Systems of equations may be solved for unknowns via an iterative process. As an example, iterations may occur for a series of time steps until a prescribed time is reached.

In the example of FIG. 2, a linearization block 240 provides for linearization of a system of equations such as those provided by the model block 230. For example, linearization of a nonlinear system of equations may occur using a Newton-Raphson method that involves formation of a Jacobian matrix of derivatives with respect to various unknowns. As an example, the subterranean formation 210 may be or planned to be intersected with one or more wells. In such an example, a system of equations may include a reservoir portion and a well portion. With respect to ordering of equations that describe such portions, the introduction of the well portion may impact ordering, matrix size, etc., compared to a system of equations that accounts for a reservoir without one or more wells. For example, a reservoir portion may result in a diagonally structured Jacobian matrix (e.g., with some diagonal band-width) while a well portion may result in addition of borders to the diagonally structured Jacobian matrix.

As an example, unknowns may include pressure “P” unknowns and saturation “S” unknowns. For example, one or more grids may be imposed upon an area of interest in a reservoir model to define a plurality of cells, each having one or more unknown properties associated therewith. Examples of unknown properties can include pressure, temperature, saturation, permeability, porosity, etc.

A solver block 250 may provide for solving a linearized system of equations (e.g., a system of linear equations), for example, for a particular time. As an example, a solver block 250 may implement a CPR method per the CPR method block 260 (see, e.g., Wallis “Incomplete Gaussian Elimination for Preconditioning of Generalized Conjugate Gradient Acceleration,” SPE Reservoir Simulation Symposium, Nov. 15-18, 1983, SPE 12265). Noting that in the example of FIG. 2, the CPR method block 260 may implement an AI smoother and a block AI preconditioner. For example, an AI smoother may be applied as part of a first stage to an AMG technique for a pressure solution while a block AI preconditioner may be applied in a second stage for purposes of achieving a full solution.

In the example of FIG. 2, the solver block 250 may iterate in an effort to reach one or more convergence criteria (e.g., acceptable error). Where time is involved, time may be incremented (e.g., via a time step) after convergence has been reached for a prior time. As an example, a solver may include a limit as to a number of iterations, for example, to avoid excessive computation times where convergence appears slow or unlikely.

As an example, a matrix may be constructed for a gridded region of interest and used in a solution process to solve for unknowns (e.g., unknown variables). A linearized system of equations may be represented by a matrix multiplied by a vector of unknowns to be equal to a vector of known or knowable values.

As to time, where an approach is fully implicit in time, a matrix may have a constant block-size; whereas, if adaptive implicit (AIM) time-stepping is used (e.g., implicit pressure and saturation (IMPSAT), IMPES, etc.), a matrix may be of variable block-size. As an example, a matrix may be ordered in a cell-by-cell manner where cells have associated unknowns. Such a matrix will include zero entries and nonzero entries. Size or shape of a block may be determined by cell neighbors or other relationships. Further, characteristics of a numerical technique may have an effect block size, shape, etc. (e.g., order of a finite difference technique, etc.).

As an example, a linear solver may utilize a direct method or an iterative method to determine a solution. As to a direct method, consider Gaussian elimination where a matrix is factorized into a product of a lower triangular matrix, L, and upper triangular matrix, U (e.g., A=LU). For large sparse matrices, computation of triangular matrices L and U can become expensive as the number of non-zero entries in each factor becomes large.

As an example, for an iterative method, a linear system of equations may be solved using approximations to a matrix. For example, an incomplete lower-upper ILU factorization may be used, instead of a full factorization as in the direct method. In such an example, a product of sparse factors L and U may be computed such that their product approximates the matrix (A≈LU). When employing an iterative method, a solution is updated in an iterative manner until convergence is reached (e.g., some proscribed error limit or limits have been met). Iterative methods may converge slowly for large systems of linear equations because the number of iterations can increase as a number of unknowns increases.

As to preconditioning, it may be implemented in an effort to decrease a number of iterations in an iterative method to reach a solution for a linear system of equations. As mentioned, in preconditioning, a matrix can be multiplied by a preconditioning matrix (e.g., “preconditioner”) that may make a linear system of equations more amenable to numerical solution without introducing unacceptable artifacts, error, etc.

Single or multi-stage preconditioners may be combined with Krylov subspace methods for solving a fully implicit or an adaptive implicit system of equations. As an example, consider an iterative procedure such as GMRES, which can accelerate convergence in a Krylov subspace (see, e.g., Saad et al. “GMRES: A Generalized Minimal Residual Algorithm for Solving Non-symmetric Linear Systems,” SIAM J. Sci. Stat. Comp., 7(3): 856-869, 1986″; and Vinsome et al. “Orthomin, an Iterative Method for Solving Sparse Sets of Simultaneous Linear Equations,” SPE Symposium on Numerical Simulation of Reservoir Performance, Feb. 19-20, 1976).

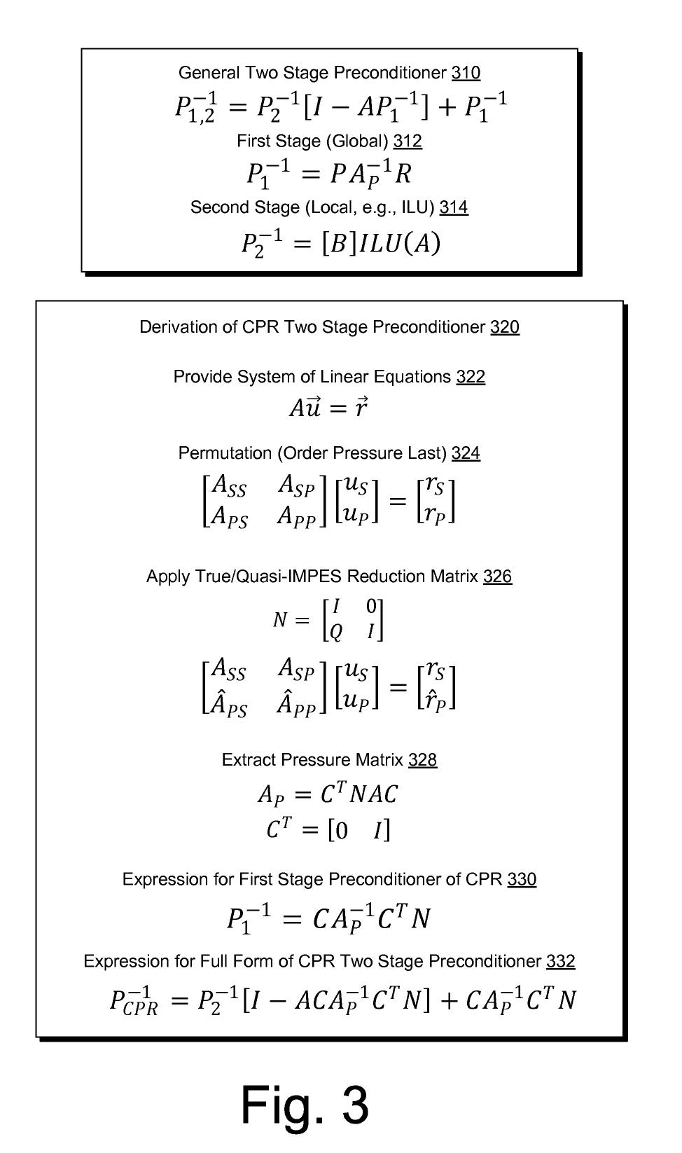

FIG. 3 shows various equations including a general two stage preconditioner equation 310, a first stage global equation 312, a second stage ILU equation 314 and equations and processes associated with derivation of a CPR two stage preconditioner 320.

As to a CPR preconditioner, it aims to exploit characteristics of pressure tending to be elliptic and a “stiff” variable by constructing a two-stage preconditioner. As shown in the example of FIG. 3, a system of linear equations may be provided 322, a permutation may be performed 324 to order pressure last to provide an ordered system of equations. A true or quasi-IMPES reduction matrix may be applied 326 and a pressure matrix extracted 328. Given the foregoing processes, an expression may be provided for a first stage preconditioner 330 and an expression may be provided for a full two stage preconditioner 332.

In the example of FIG. 3, expressions for a full two stage preconditioner can include a first stage preconditioner that decouples pressure from other unknowns (e.g., saturations, concentrations, etc.) for application of a solver to a system of pressure equations (e.g., with elliptic behavior) and a second stage preconditioner that acts to resolve the original coupling between pressure and the other unknowns.

As shown in the example of FIG. 3, a second stage preconditioning of a CPR method may include an ILU process (see expression 314). In contrast, the example of FIG. 2 shows a CPR preconditioner that implements a block AI second stage preconditioner. Further, as indicated in the example of FIG. 2, a CPR method can implement an AI smoother.

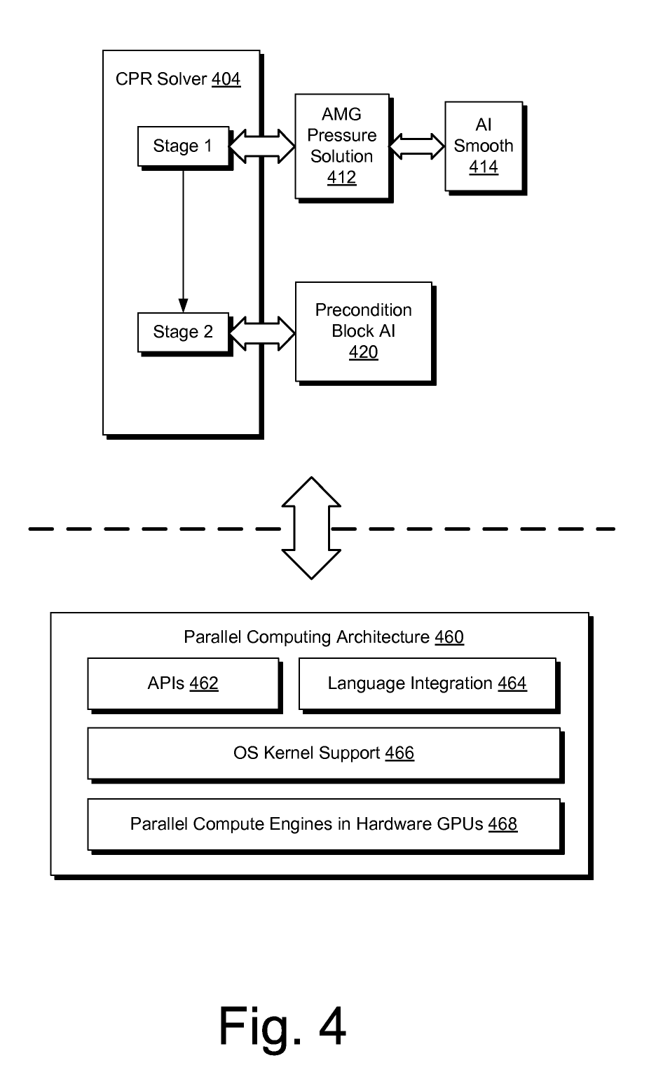

FIG. 4 shows an example of a CPR solver block 404 that includes two stages where a first stage can include true or quasi-IMPES reduction to decouple pressure and other variables, an AMG block 412 for providing a pressure solution and a AI smoother block 414 for smoothing and where a second stage can include a block AI preconditioner block 420. FIG. 4 also shows a parallel computing architecture 460 that includes a one or more application programming interfaces (APIs) block 462, a code integration block 464, an OS kernel support block 466 and a parallel compute engines in GPUs block 468.

In the example of FIG. 4, the block AI preconditioner of the block 420 may be applied, in context of the CPR solver block 404, with respect to the second stage for parallelism. As mentioned with respect to FIG. 3, while a CPR approach may use ILU for a second stage, ILU is recursive and therefore not advantageous for parallelism. As indicated in FIG. 4, the CPR solver block 404 may interact with the parallel computing architecture 460. Further, as mentioned, an AI smoother, and optionally other processes of a first stage, may be subject to parallelization.

As an example, where a system of equations may include a million or more unknowns, a block AI preconditioner may be applied to blocks of equations (e.g., in global matrix provided with first stage pressure solution) having about 8 to 18 unknowns with corresponding matrix sizes less than about 200×200. As an example, a block size of blocks may be in a range from about 3 to about 20.

As an example, a parallel computing architecture may include one or more features of GPU-related NVIDIA® technology (Santa Clara, Calif.). For example, the parallel computing architecture 460 may include one or more features of the NVIDIA® CUDA™ technology, the NVIDIA® Tesla™ technology, etc. As an example, an application may execute at least in part on an installed GPU or GPUs in a desktop computer, a notebook computer, a workstation, a supercomputer cluster, etc. As an example, a GPU may include hundreds of cores and be configured to run thousands of parallel threads. As an example, a parallel computing architecture may include features for interactions via the .NET™ framework. As an example, a solver such as the CPR solver 404 may integrate with the OCEAN® framework.

As an example, a parallel computing architecture may include various components such as parallel compute engines inside GPUs, OS kernel-level support for hardware initialization, configuration, etc., user-mode driver (e.g., to provide a device-level API for developers, etc.), a PTX instruction set architecture (ISA) for parallel computing kernels and functions. As an example, a computing architecture can include type integration functionality that allows for standard types, vector types, user-defined types (e.g., including structs), etc. (e.g., to facilitate execution of functions whether CPU, GPU, etc.).

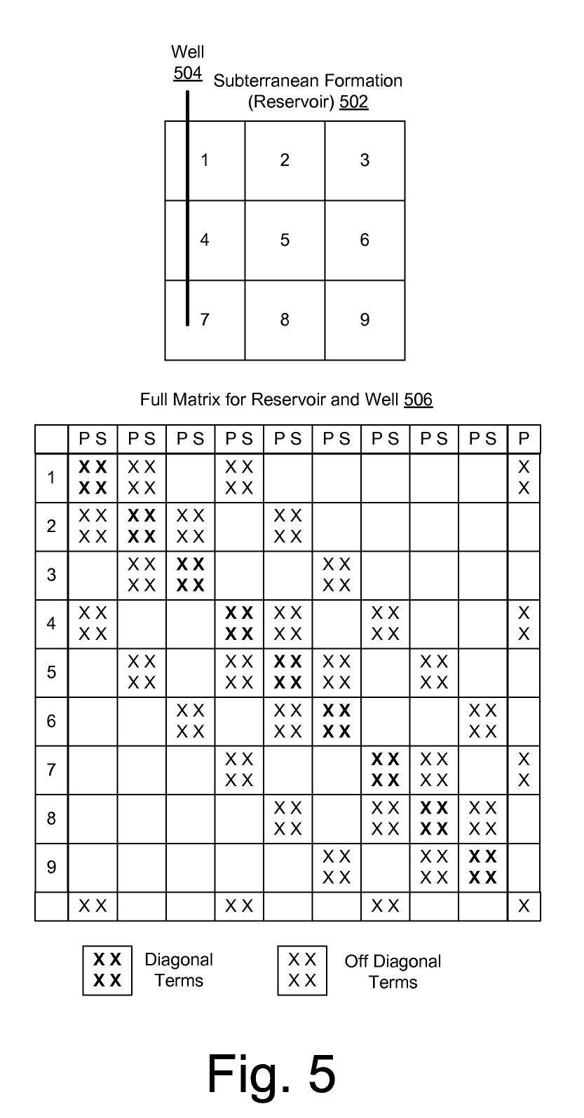

FIG. 5 shows an example of a subterranean formation 502 that may include a reservoir and a well 504 and a matrix 506 that represents terms for equations for pressure (e.g., P) and other variables (e.g., saturation S). As indicated, the matrix has diagonal terms, various off diagonal terms that may define a band-width and a border with a border width. While the example of FIG. 5 may appear to be structured (e.g., geometrically), a model of a subterranean formation may be structured, unstructured or a combination of structured and unstructured with respect to one or more grids.

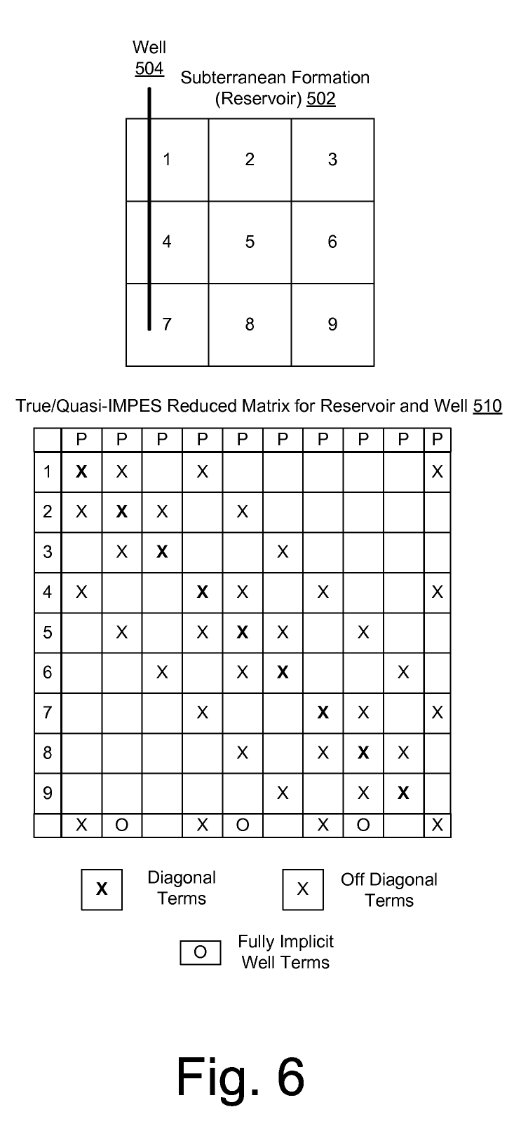

FIG. 6 shows a reduced matrix 510, for example, a reduction of the matrix 506 of the example of FIG. 5 achieved via application of a true or quasi-IMPES reduction technique. In particular, the matrix 510 includes pressure terms, as represented by columns labeled “P”; whereas, the matrix 506 includes both pressure and saturation terms as represented by columns labeled “PS”.

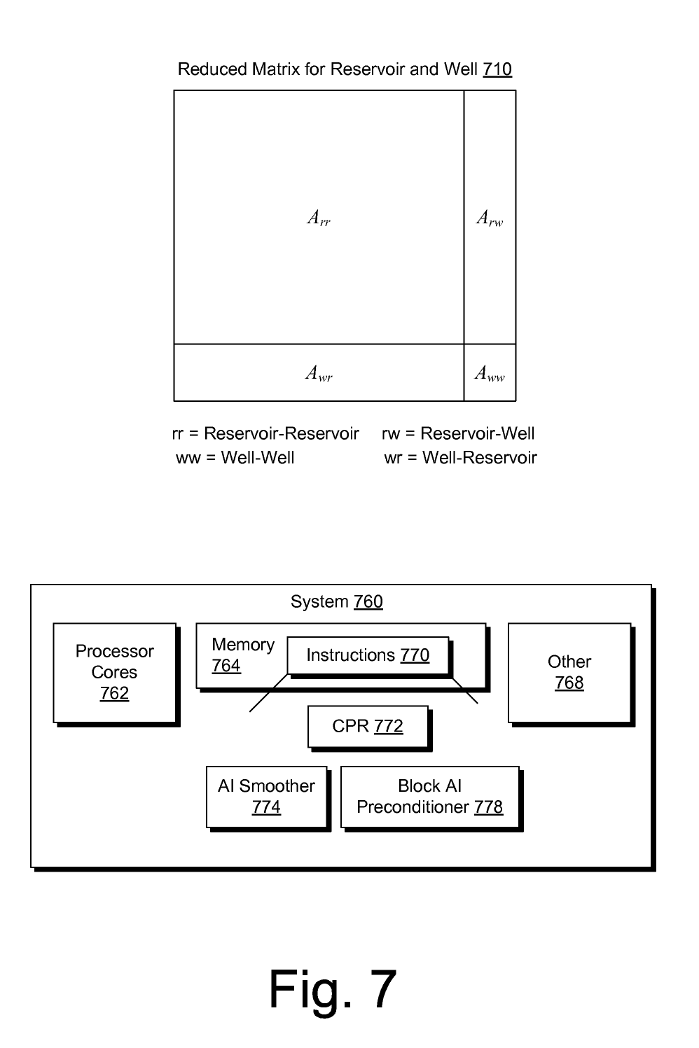

FIG. 7 shows an example of a reduced matrix 710 that includes various regions. For example, the matrix 710 includes a reservoir-reservoir region, a well-well region, a reservoir-well region and a well-reservoir region. FIG. 7 also shows an example of a system 760.

In the example of FIG. 7, the system 760 can include processor cores 762, memory 764, instructions 770 and one or more other features 768. As to the instructions 770, these can include instructions stored in the memory and executable by the processor cores to implement one or more approximate inverse techniques (e.g., optionally in parallel). As an example, the processor cores 762 can include one or more multi-core GPUs, which may optionally each include at least about one hundred cores. As an example, the instructions 770 may include instructions for a constrained pressure residual method 772, an approximate inverse smoother 774, and a block approximate inverse preconditioner 778.

As an example, a system can include processor cores, memory and instructions stored in the memory and executable at least in part in parallel by the processor cores to implement a constrained pressure residual method for a model of physical phenomena associated with a geologic formation, where the constrained pressure residual method may include execution of instructions for an approximate inverse smoother, a block approximate inverse preconditioner, or an approximate inverse smoother and a block approximate inverse preconditioner. In such an example, the number of processor cores may be at least about one hundred. As an example, processor cores may be GPU processor cores.

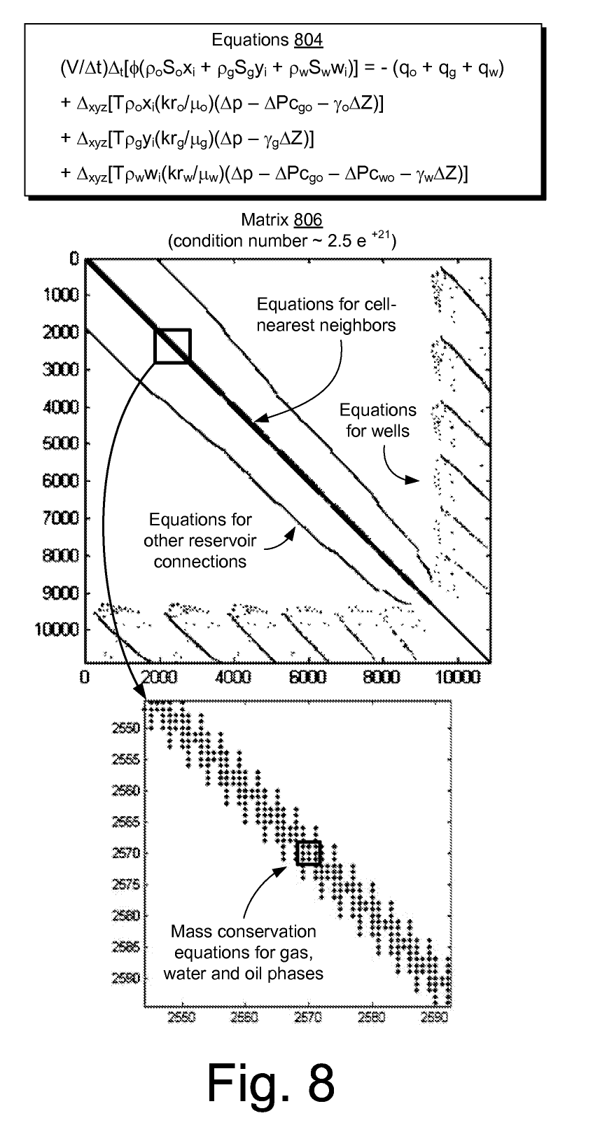

FIG. 8 shows an example of equations 804 that can model physical phenomena for a geologic formation and an example of a matrix 806 that includes terms for various equations that can model physical phenomena for a geologic formation that includes a reservoir and one or more wells.

The equations 804 are shown in finite difference form and describe how values of dependent variables in a grid cell, such as pressure (p) (e.g., including capillary pressure (Pc)), temperature (T), saturation (S), mole fraction (e.g., liquid mole fraction (xᵢ), vapor mole fraction (yᵢ), aqueous mole fraction (wᵢ) where the subscript “i” equals 1 to the number of components) and mass rate (q), can change with respect to time (t). The equations 804 are shown with respect to subscripts for oil (o), gas (g) and water (w) along with liquid mole fraction (xᵢ), vapor mole fraction (yᵢ), aqueous mole fraction (wᵢ), vertical depth (Z). The equations 804 include various property related terms including porosity (φ), pore volume (V), viscosity (μ), mass density (ρ), gravity density (γ) and permeability (k) (see, e.g., DeBaun et al., “An Extensible Architecture for Next Generation Scalable Parallel Reservoir Simulation”, SPE 93274, 2005 19th SPE Reservoir Simulation Symposium, Texas, which is incorporated by reference herein).

The matrix 806 may be used for linearized reservoir simulation equations where unmarked spaces represent matrix positions with no equations and where each dot represents a derivative of one equation with respect to one variable. As indicated, outer bands include terms for well-associated equations, a diagonal with relatively close off diagonal entries include terms for cells and their nearest neighbors and relatively distant off diagonal entries include terms for other types of reservoir connections. In the enlarged portion, the nine points represent terms for mass conservation equations for gas, water and oil phases.

In the example of FIG. 8, the matrix 806 has a condition number of about 2.5e⁺²¹ and a number of unknowns greater than about ten thousand. However, upon analysis, it may be determined that the diagonal and close off diagonal entries may be defined by a block (e.g., a block structure).

As an example, a solver can implement one or more AI techniques that can algebraically decompose a system of equations into subsystems that may be handled computationally based on their particular characteristics to facilitate solution. The resulting equations may be solved numerically by, for example, an iterative technique until convergence is reached for an entire system, which may include wells, surface facilities, etc. As an example, such a solver may handle structured grids, unstructured grids or a combination of both. As an example, a field management module may allow for integration of solver results from one or more types of solvers and, for example, a surface network simulator. As an example, a simulator may include one or more features of a simulator such as the ECLIPSE™ reservoir simulator (Schlumberger, Houston Tex.), the INTERSECT™ reservoir simulator (Schlumberger, Houston Tex.), etc. As an example, a reservoir or reservoirs may be simulated with respect to one or more enhanced recovery techniques (e.g., consider a thermal process such as SAGD, etc.).

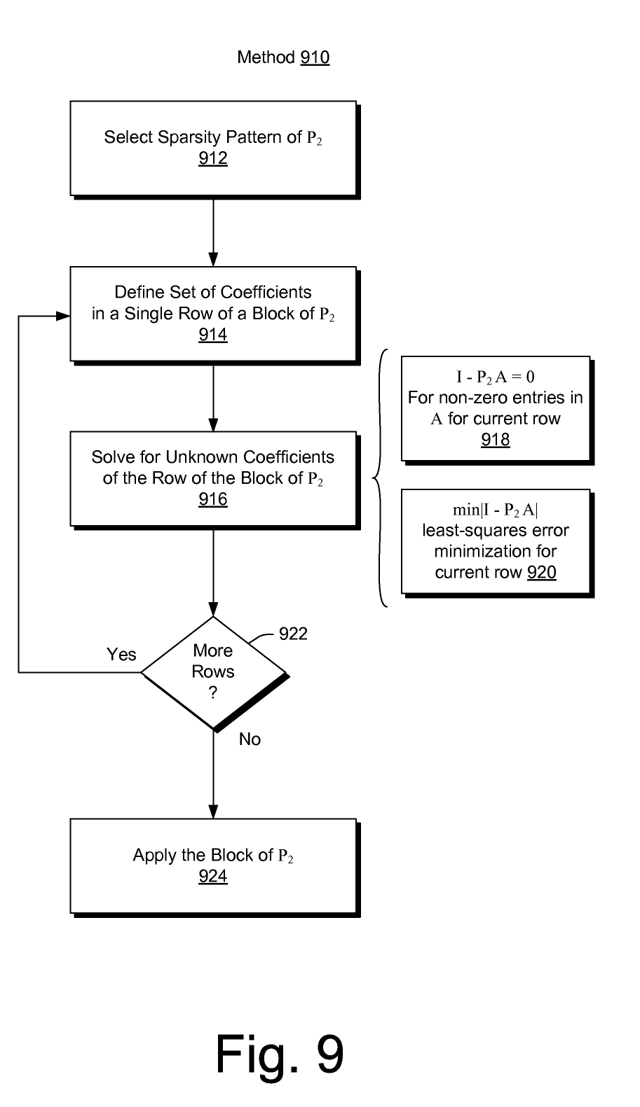

FIG. 9 shows an example of a method 910 for implementing one or more AI techniques. The method 910 includes a selection block 912 for selecting a sparsity pattern for a block AI preconditioner P₂, a definition block 914 for defining a set of coefficients in a single row of a block of P₂, a solution block 916 for solving for unknown coefficients of the row of the block of P₂, and a decision block 922 for deciding whether more rows exist. If the decision block 922 decides that more rows exist, then the method 910 returns to the definition block 914; otherwise, the method 910 continues to an application block 924 that applies the block of P₂ as a block AI preconditioner.

In the example of FIG. 9, as indicated, the solution block 916 may take one of several approaches. For example, one approach, per block 918, may follow the Frederickson method where a product P₂A is to match an identity matrix I in non-zero locations of A for a current row. As another example, another approach, per block 920, may follow a least-squares approach where least-squares error is minimized between a product P₂A and an identity matrix I for a current row.

As an example, a method can include solving linearized systems of equations that arise in implicit or adaptive implicit reservoir simulations, at least in part, via parallel computing. As an example, a two stage CPR approach can include solving a pressure equation using an AMG technique and applying a block AI preconditioner in a second stage.

As an example, a block AI preconditioning algorithm may include selecting (e.g., choosing) a sparsity pattern of an approximate inverse preconditioner matrix P, for example, which may be a sparsity pattern of an original matrix A, or its transpose. As an example, it may also be possible to expand a sparsity pattern to include additional entries.

Following selection of a sparsity pattern, an algorithm can include defining a set of coefficients in a single row (e.g., within a block) of the preconditioner P as a current set of unknowns. Following definition of such a set of coefficients, an algorithm can include solving for the current set of unknowns using, for example, one of the following approaches: such that the product PA matches the identity I in the non-zero locations of A for the current row (e.g., Frederickson method); or such that the least-squares error is minimized between the product PA and the identity I for the current row (e.g., least-squares method).

As to providing a solution, small dense local linear systems may exist for each row where, for example, a small dense matrix remains constant for each row in a given block. In such an example, while the right-hand sides can change for individual rows, reuse of the dense matrix factorization is possible. Thus, where reuse is possible, it can provide for efficiencies and parallelization.

As an example, well terms may be included while setting up a least-squares system, which can make a second stage preconditioner more effective (e.g., compared to neglecting such terms).

As an example, an algorithm may, once coefficients in a block AI preconditioner are computed, apply the block AI preconditioner by a block sparse matrix vector multiply.

As an example, construction and application of a block AI preconditioner can be accomplished for each block independently of others, which can have several consequences: (a) the block AI preconditioner can be efficiently implemented in parallel on a number of processors; (b) the number of processors used does not affect the convergence properties of the preconditioner; and (c) the block AI preconditioner can be equally efficient whatever order the equations are processed in.

As mentioned, a multigrid solution of a pressure equation can include a smoothing method as part of its algorithm. While a serial technique such as stationary iterative Gauss-Seidel technique or ILU technique may be implemented. However, where a two stage CPR method is to include parallelization for both first and second stages, as mentioned, an AI smoother may be implemented.

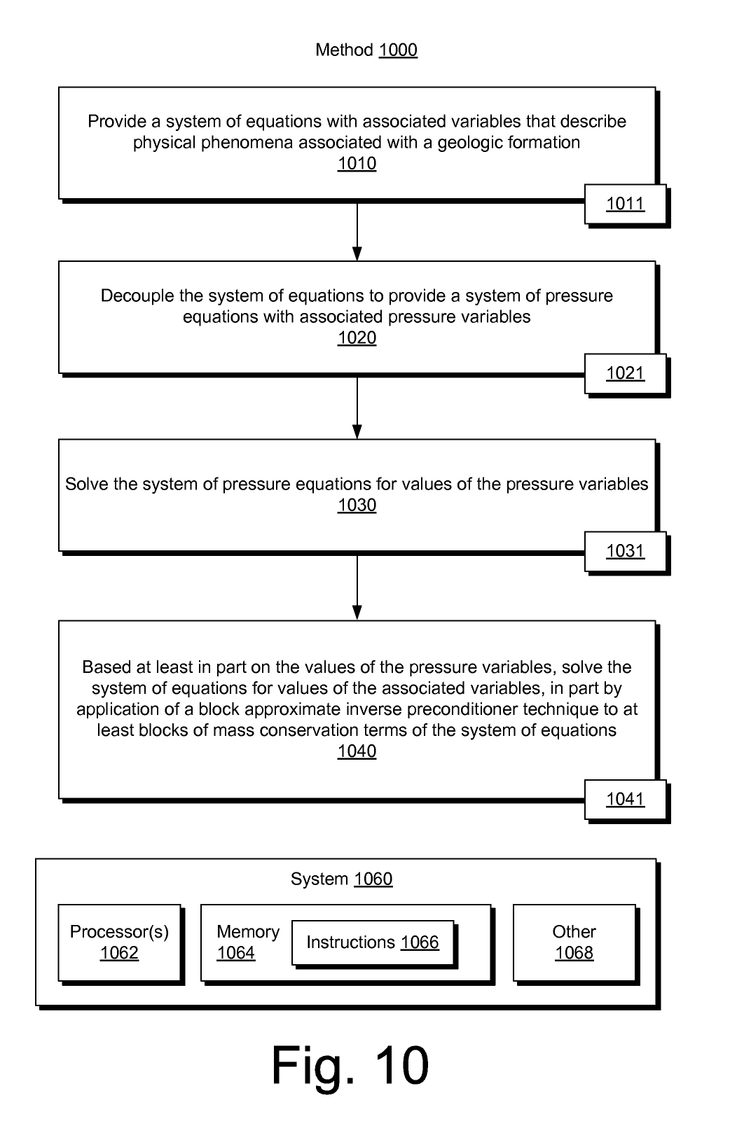

FIG. 10 shows an example of a method 1000 and an example of a system 1060. As to the method 1000, it includes a provision block 1010 for providing a system of equations with associated variables that describe physical phenomena associated with a geologic formation; a decouple block 1020 for decoupling the system of equations to provide a system of pressure equations with associated pressure variables; a solution block 1030 for solving the system of pressure equations for values of the pressure variables; and a solution block 1040 for, based at least in part on the values of the pressure variables, solving the system of equations for values of the associated variables where the solving the system of equations can include applying a block approximate inverse preconditioner technique to at least blocks of mass conservation terms of the system of equations. As an example, such a method can include applying an approximate inverse smoother to the system of pressure equations and the values of the pressure variables.

As to the system 1060, in the example of FIG. 10, it includes one or more processors 1062, memory 1064, instructions 1066 and other features 1068 (e.g., one or more features of a computing platform such as a desktop computer, a laptop computer, a server, a workstation, etc.). As an example, where the one or more processors 1062 include a multi-core GPU, the instructions 1066 can include instructions stored in the memory 1064 and executable by the multi-core GPU to, based at least in part on values of pressure variables of a system of equations with associated variables that describe physical phenomena associated with a geologic formation, apply a block approximate inverse preconditioner technique to at least blocks of mass conservation terms of the system of equations to solve the system of equations for values of the associated variables.

As an example, a method can include solving a system of pressure equations by implementing an algebraic multigrid technique. As an example, a method can include applying a block approximate inverse technique in parallel to at least blocks of mass conservation terms of a system of equations. As an example, a method can include providing a computing platform, for example, that includes one or more multi-core GPUs and implementing the computing platform to perform at least part of the method using parallel processing (e.g., per use of an approximate inverse smoother, preconditioner, etc.).

As an example, a method can include selecting a sparsity pattern for a block approximate inverse preconditioner matrix and defining a set of coefficients for a single row within a block of the block approximate inverse preconditioner matrix as a current set of unknowns. As an example, such a method can include solving for values of the current set of unknowns by matching entries for a single row of a product matrix, defined as a product of a matrix for a system of equations and the block approximate preconditioner matrix, to identities of non-zero entries of the matrix for the system of equations within the selected sparsity pattern. As an example, such a method may include application of an algorithm according to the following equation:

(I−PA)ᵢⱼ=0, for all (i,j)εS (14)

where I is the identity matrix, P is the block approximate inverse preconditioner matrix, A is the matrix for the system of equations, i and j are matrix indices and S is the selected sparsity pattern as a matrix.

As an example, a method can include selecting a sparsity pattern for a block approximate inverse preconditioner matrix and defining a set of coefficients for a single row within a block of the block approximate inverse preconditioner matrix as a current set of unknowns. As an example, such a method can include solving for values of the current set of unknowns by minimizing least-squares error between entries for a single row of a product matrix, defined as a product of a matrix for a system of equations and the block approximate preconditioner matrix, and identities of non-zero entries of the matrix for the system of equations within the selected sparsity pattern. As an example, such a method may include application of an algorithm according to the following equation:

$${min}_{P ∈ S} {‖ I - PA ‖}_{F} \\ where \\ {‖ A ‖}_{F} = \sqrt{{\sum }_{i = 1}^{n} {\sum }_{j = 1}^{n} {\vert {a}_{ij} \vert}^{2}} = \sqrt{trace ( {A}^{*} A )} \qquad ( 15 )$$

and where I is the identity matrix, P is the block approximate inverse preconditioner matrix, A is the matrix for the system of equations with entries aᵢⱼ, i and j are matrix indices, S is the selected sparsity pattern as a matrix and the subscript F represents a Frobenius norm.

As an example, a method can include linearizing a system of equations, for example, by implementing a Newton-Raphson technique. As an example, a method can include providing a time increment where solving a system of equations for values of associated variables provides values for a particular number of the time increments.

As an example, a system can include instructions stored in memory and executable by a multi-core GPU to select a sparsity pattern for a block approximate inverse preconditioner matrix and define a set of coefficients for a single row within a block of the block approximate inverse preconditioner matrix as a current set of unknowns. In such an example, instructions stored in the memory and executable by the multi-core GPU may be provided to solve for values of the current set of unknowns by matching entries for a single row of a product matrix, defined as a product of a matrix for the system of equations and the block approximate preconditioner matrix, to identities of non-zero entries of the matrix for the system of equations within the selected sparsity pattern.

As an example, a system can include instructions stored in memory and executable by a multi-core GPU to select a sparsity pattern for a block approximate inverse preconditioner matrix and define a set of coefficients for a single row within a block of the block approximate inverse preconditioner matrix as a current set of unknowns. In such an example, instructions stored in memory and executable by a multi-core GPU may be provided to solve for values of the current set of unknowns by minimizing least-squares error between entries for a single row of a product matrix, defined as a product of a matrix for the system of equations and the block approximate preconditioner matrix, and identities of non-zero entries of the matrix for the system of equations within the selected sparsity pattern.

The method 1000 is shown in FIG. 10 in association with various computer-readable media (CRM) blocks 1011, 1021, 1031, and 1041. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1000. As an example, a computer-readable medium (CRM) may be a computer-readable storage medium.

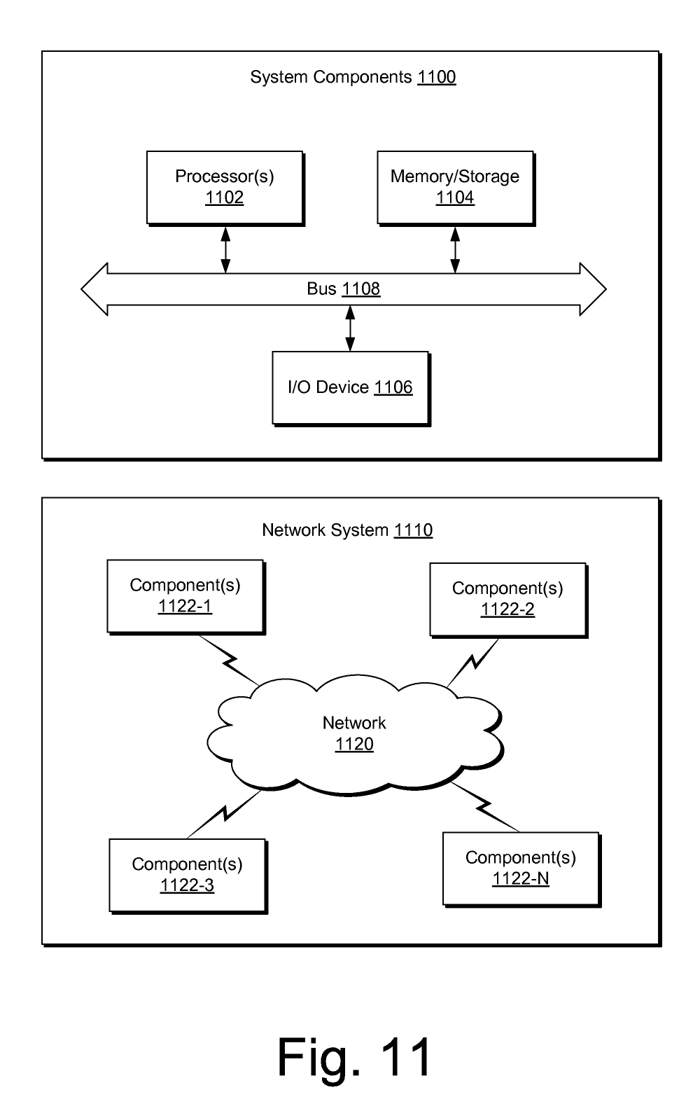

FIG. 11 shows components of an example of a computing system 1100 and an example of a networked system 1110. The system 1100 includes one or more processors 1102, memory and/or storage components 1104, one or more input and/or output devices 1106 and a bus 1108. In an example embodiment, instructions may be stored in one or more computer-readable media (e.g., memory/storage components 1104). Such instructions may be read by one or more processors (e.g., the processor(s) 1102) via a communication bus (e.g., the bus 1108), which may be wired or wireless. The one or more processors may execute such instructions to implement (wholly or in part) one or more attributes (e.g., as part of a method). A user may view output from and interact with a process via an I/O device (e.g., the device 1106). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1110. The network system 1110 includes components 1122-1, 1122-2, 1122-3, . . . 1122-N. For example, the components 1122-1 may include the processor(s) 1102 while the component(s) 1122-3 may include memory accessible by the processor(s) 1102. Further, the component(s) 1102-2 may include an I/O device for display and optionally interaction with a method. The network may be or include the Internet, an intranet, a cellular network, a satellite network, etc.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

1. A method comprising:
providing a system of equations with associated variables that describe physical phenomena associated with a geologic formation;
decoupling the system of equations to provide a system of pressure equations with associated pressure variables;
solving the system of pressure equations for values of the pressure variables; and
based at least in part on the values of the pressure variables, solving the system of equations for values of the associated variables wherein the solving the system of equations comprises applying a block approximate inverse preconditioner technique to at least blocks of mass conservation terms of the system of equations.

2. The method of claim 1 comprising applying an approximate inverse smoother to the system of pressure equations and the values of the pressure variables.

3. The method of claim 1 comprising solving the system of pressure equations by implementing an algebraic multigrid technique.

4. The method of claim 1 comprising applying the block approximate inverse technique in parallel to at least the blocks of mass conservation terms of the system of equations.

5. The method of claim 1 comprising providing a computing platform that comprises one or more multi-core GPUs and implementing the computing platform to perform at least part of the method using parallel processing.

6. The method of claim 1 comprising selecting a sparsity pattern for a block approximate inverse preconditioner matrix and defining a set of coefficients for a single row within a block of the block approximate inverse preconditioner matrix as a current set of unknowns.

7. The method of claim 6 comprising solving for values of the current set of unknowns by matching entries for a single row of a product matrix, defined as a product of a matrix for the system of equations and the block approximate preconditioner matrix, to identities of non-zero entries of the matrix for the system of equations within the selected sparsity pattern.

8. The method of claim 7 comprising the following equation:
(I−PA)ᵢⱼ=0, for all (i,j)εS
where I is the identity matrix, P is the block approximate inverse preconditioner matrix, A is the matrix for the system of equations, i and j are matrix indices and S is the selected sparsity pattern as a matrix.

9. The method of claim 6 comprising solving for values of the current set of unknowns by minimizing least-squares error between entries for a single row of a product matrix, defined as a product of a matrix for the system of equations and the block approximate preconditioner matrix, and identities of non-zero entries of the matrix for the system of equations within the selected sparsity pattern.

10. The method of claim 9 comprising the following equation:
$${min}_{P ∈ S} {‖ I - PA ‖}_{F}$$
$$where$$
$${‖ A ‖}_{F} = \sqrt{{\sum }_{i = 1}^{n} {\sum }_{j = 1}^{n} {\vert {a}_{ij} \vert}^{2}} = \sqrt{trace ( {A}^{*} A )}$$
and where I is the identity matrix, P is the block approximate inverse preconditioner matrix, A is the matrix for the system of equations with entries aᵢⱼ, i and j are matrix indices, S is the selected sparsity pattern as a matrix and the subscript F represents a Frobenius norm.

11. The method of claim 1 comprising linearizing the system of equations.

12. The method of claim 11 comprising implementing a Newton-Raphson technique for linearizing the system of equations.

13. The method of claim 1 comprising providing a time increment wherein solving the system of equations for values of the associated variables provides values for a particular number of the time increments.

14. A system comprising:
a multi-core GPU;
memory; and
instructions stored in the memory and executable by the multi-core GPU to, based at least in part on values of pressure variables of a system of equations with associated variables that describe physical phenomena associated with a geologic formation, apply a block approximate inverse preconditioner technique to at least blocks of mass conservation terms of the system of equations to solve the system of equations for values of the associated variables.

15. The system of claim 14 comprising instructions stored in the memory and executable by the multi-core GPU to select a sparsity pattern for a block approximate inverse preconditioner matrix and define a set of coefficients for a single row within a block of the block approximate inverse preconditioner matrix as a current set of unknowns.

16. The system of claim 15 comprising instructions stored in the memory and executable by the multi-core GPU to solve for values of the current set of unknowns by matching entries for a single row of a product matrix, defined as a product of a matrix for the system of equations and the block approximate preconditioner matrix, to identities of non-zero entries of the matrix for the system of equations within the selected sparsity pattern.

17. The system of claim 15 comprising instructions stored in the memory and executable by the multi-core GPU to solve for values of the current set of unknowns by minimizing least-squares error between entries for a single row of a product matrix, defined as a product of a matrix for the system of equations and the block approximate preconditioner matrix, and identities of non-zero entries of the matrix for the system of equations within the selected sparsity pattern.

18. A system comprising:
processor cores;
memory; and
instructions stored in the memory and executable at least in part in parallel by the processor cores to
implement a constrained pressure residual method for a model of physical phenomena associated with a geologic formation wherein the constrained pressure residual method comprises execution of instructions for
an approximate inverse smoother,
a block approximate inverse preconditioner, or
an approximate inverse smoother and a block approximate inverse preconditioner.

19. The system of claim 18 wherein the processor cores comprise at least one hundred cores.

20. The system of claim 18 wherein the processor cores comprise GPU processor cores.
